(19) United States
(12) Patent Application Publication
(10) Pub. No.: US 2026/0211566 A1
(43) Pub. Date: Jul. 23, 2026

(54) MEMORY SYSTEMS, ELECTRONIC DEVICES, METHODS FOR CONTROLLING MEMORY SYSTEMS AND STORAGE MEDIA

(71) Applicant: Yangtze Memory Technologies Co., Ltd., Wuhan (CN)

(72) Inventors: Chao Wu, Wuhan (CN); Yalei Wang, Wuhan (CN)

(21) Appl. No.: 19/236,263

(22) Filed: Jun. 12, 2025

(30) Foreign Application Priority Data
Jan. 22, 2025 (CN) 202510104302.1

(51) Int. Cl. G06F 3/06

(52) U.S. Cl. CPC G06F 3/0625; G06F 3/0653; G06F 3/0679

(57) ABSTRACT

An example memory system includes a memory device and a memory controller, wherein the memory controller is configured to acquire signal offset data for a reference clock signal in response to identifying a state abnormal event, wherein the signal offset data indicates an offset status of the reference clock signal; and execute an offset processing strategy in response to the signal offset data satisfying an offset threshold.

### CROSS-REFERENCE TO RELATED APPLICATION

This application claims priority to and the benefit of Chinese Patent Application 202510104302.1, filed on January 22, 2025, which is hereby incorporated by reference in its entirety.

### FIELD OF TECHNOLOGY

The present application relates to the field of memory technology, and in particular to memory systems, electronic devices, methods for controlling memory systems and storage media.

### BACKGROUND

In Universal Flash Storage (UFS), a host is used to provide a reference clock signal, and the data sent by the host is decoded based on the reference clock signal provided by the host.

### BRIEF DESCRIPTION OF THE DRAWINGS

In order to illustrate the technical solution in the examples of the present application more clearly, the accompanying drawings to be used in the description of the examples will be briefly introduced below. Obviously, the accompanying drawings in the following description are only some of the examples of the present application. For ordinary skills in the art, other drawings can be obtained according to the accompanying drawings without creative labor.

FIG. 1 is a schematic diagram of a system having a memory system provided by the examples of the present application.

FIG. 2 is a flowchart of a method for controlling a memory system provided by the examples of the present application.

FIG. 3 is a schematic diagram of a structure of a memory system provided by the examples of the present application.

FIG. 4 is a flowchart of a method for controlling a memory system in a high temperature situation provided by the examples of the present application.

FIG. 5 is a flowchart of a method for controlling a memory system in a low temperature situation provided by the examples of the present application.

FIG. 6 is a flowchart of a method for controlling a memory system based on a hardware reset provided by the examples of the present application.

FIG. 7 is a flowchart of a method for controlling a memory system in a voltage abnormal event provided by an example of the present application.

FIG. 8 is a flowchart of a method for controlling a memory system based on device management entity errors provided by the examples of the present application.

FIG. 9 is a schematic diagram of a structure of a memory system provided by the examples of the present application.

FIG. 10 is a schematic diagram of a structure of a memory device provided by the examples of the present application.

FIG. 11 is a schematic diagram of a structure of a memory device provided by the examples of the present application.

FIG. 12 is a schematic diagram of a structure of a memory system provided by the examples of the present application.

### DETAILED DESCRIPTION

The examples of the present application are further described in detail in combination with the accompany drawings.

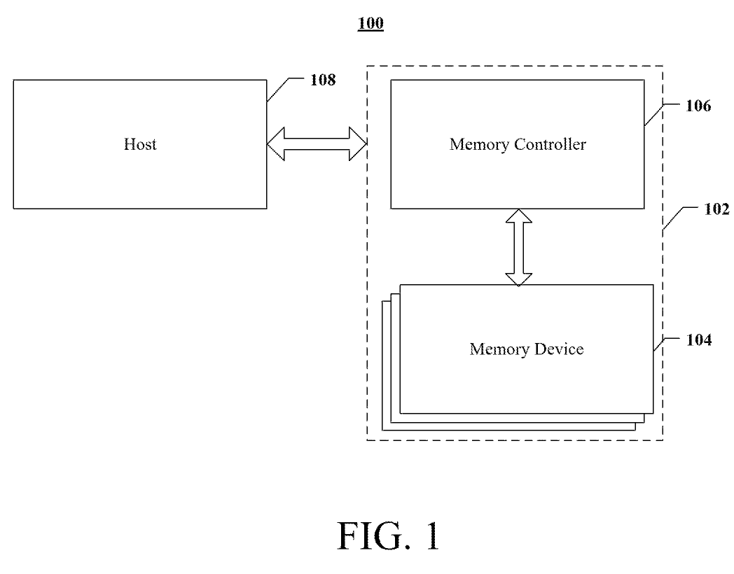

The method for controlling the memory system provided by the examples of the present application can be applied to a system with a memory system. As shown in FIG. 1, a system 100 comprises a memory system 102 and a host 108 coupled to the memory system 102. The memory system 102 comprises one or more memory devices 104 and a memory controller 106 coupled to the one or more memory devices 104 and configured to control the memory devices 104.

The memory system 102 can be implemented as a type of memory system such as Universal Flash Storage (UFS), Solid State Disk (SSD), and the like. In the examples of the present application, the memory system 102 is implemented as UFS as an example for illustration.

The UFS utilizes the UFS interface standard protocol, which is a high-performance, low-power consumption memory interface standard protocol capable of being applied to mobile devices and embedded systems. The UFS interface standard protocol is capable of supporting high-speed data transfer and low-power consumption.

The UFS is designed with at least two power consumption states, which comprise active and inactive modes, to accommodate different power consumption requirements. The UFS provides a variety of error detection and correction mechanisms, such as Cyclic Redundancy Check (CRC) and Error-Correcting Code (ECC), to ensure data reliability.

The UFS is highly adaptable and suitable for a variety of mobile devices, including smartphones, tablets, and embedded systems.

The UFS, as an advanced memory technology, is designed with the goal of providing a high-performance, high-reliability, and low-power consumption memory solution to meet the high demand for memory performance in mobile devices. As the technology evolves, the UFS interface standard protocols are continuously updated to support higher data transfer rates and larger storage capacities.

The UFS, as a passive device, needs to additionally provide signals such as power supply and reference clock, etc. Currently for the power supply, there are mechanisms such as Voltage Detection and Tuning (VDT) to ensure the stability of the power supply, whereas for the reference clock signal, it is currently only possible to rely on the good quality of the signal provided by the host 108.

In the UFS interface standard protocol 4.1, a quality detection function for the reference clock signal is given, and the signal quality of the reference clock signal is detected by a detection circuit. In the examples of the present application, the ability of the memory system 102 to detect the environment is increased, and preventive protection measures are done according to the quality of the reference clock signal to improve the stability and quality of the device. When an operating environment of the UFS is unstable, the operating environment affects the performance of the reference clock signal in the UFS in terms of phase, frequency, or amplitude.

The examples of the application provide a method for controlling a memory system, which can increase the detection of the quality of the reference clock signal according to a strategy when the memory system identifies extreme environments, such as high and low temperatures, voltage abnormalities, and hardware reset events, and increase or decrease the privileges of some background operations according to the strategy to reduce the power requirements on the system and maintain the stability of the system.

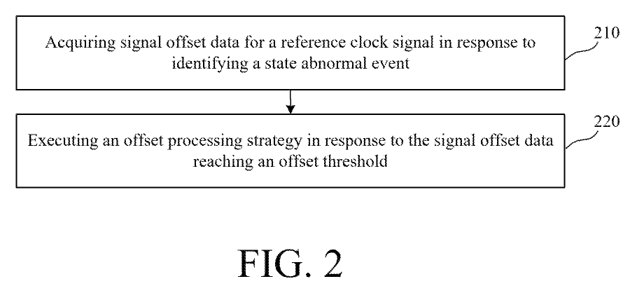

FIG. 2 is a flow chart of a method for controlling a memory system provided by an example of the application, which is executed by a memory system 102 comprising a memory device 104 and a memory controller 106. As shown in FIG. 2, the method comprises the following operations:

At operation 210, acquiring signal offset data for a reference clock signal in response to identifying a state abnormal event.

The signal offset data indicates an offset status of the reference clock signal.

In some examples, the signal offset data indicates an offset status between a physical manifestation of the reference clock signal and configuration information, and the physical manifestation comprises a manifested frequency of the reference clock signal, and the configuration information comprises a configuration frequency and is sent by the host 108.

In some examples, the state abnormal event comprises a preset event for indicating that there is an anomaly in the operation of the memory system 102, which includes at least one of an anomaly in the operating temperature of the memory system 102, or an anomaly in a process of operation of the memory system.

Schematically, the state abnormal event comprises at least one of an operating temperature of the memory system 102 being too high, the operating temperature being too low, a hardware reset event, a voltage abnormal event, or Device Management Entity (DME) errors.

The memory system 102 comprises a temperature sensor for collecting the operating temperature of the memory system 102 during operation. In some examples, the operating temperature includes at least one of an operating temperature of the memory device 104 or an operating temperature of the memory controller 106.

The operating temperature being too high comprises the operating temperature obtained by the temperature sensor of the memory system 102 reaching a first temperature threshold; the operating temperature being too low includes the operating temperature obtained by the temperature sensor of the memory system 102 being less than a second temperature threshold, wherein the second temperature threshold is less than the first temperature threshold. When the memory system 102 operates in a high-temperature environment, electronic components are prone to thermal expansion, resulting in a decrease in the operating speed of the memory system 102, which may even result in data loss. In addition, the high temperature increases the energy consumption of the memory system 102, which increases the heat dissipation burden of the computer, which in turn affects the operational stability of the memory system 102. In a low-temperature environment, the circuits of the memory system 102 may become sluggish, resulting in a slowdown in the transmission of electrical signals. In addition, the low temperature increases the power consumption of the memory system 102 and reduces the operational performance of the memory system 102. Schematically, the first temperature threshold is 140 ℉ (60 ℃), and the second temperature threshold is 77 ℉ (25 ℃). When the operating temperature of the memory system 102 is greater than or equal to 140 ℉ (60 ℃), it indicates that the memory system 102 is operating at too high a temperature; similarly, when the operating temperature of the memory system 102 is less than or equal to 77 ℉ (25 ℃), it indicates that the memory system 102 is operating at too low a temperature.

In the case where the memory system 102 is implemented as a UFS, for example, a UFS hardware reset event refers to a reset operation of the UFS via a hardware reset signal. In some examples, the reasons for the hardware reset event include at least one of the followings.

1. Power supply and system abnormity. Schematically, a ripple on the power supply or external static electricity may cause the power supply voltage to be pulled down, which triggers the level of the pin used for system reset to be pulled down, which in turn causes the hardware reset for the UFS is triggered.

2. The memory controller 106 receives a reset command.

3. The protection mechanism in the memory system 102 triggers a hardware reset. In the design of the memory system 102, a protection mechanism may be set, and when an abnormal condition is detected (such as voltage fluctuation or overload), the system may automatically execute a hardware reset to protect the device.

4. External intervention. For example, manually triggering a reset button or sending a reset signal through an external device may also cause a hardware reset event. It is noteworthy that the above reasons for generating the hardware reset are only schematic examples, and the examples of the present application are not limited thereto. In some examples, In some examples, the hardware reset signal is active low, meaning that the hardware reset operation is triggered when the hardware reset signal is low. According to UFS standard, the duration of the low level of the hardware reset signal should be greater than or equal to 1 microsecond (us), and signals with durations less than 100 nanoseconds (ns) cannot be detected by the UFS.

The voltage abnormal event refers to an event where there is a fluctuation in the power supply. Taking the memory system 102 implemented as a UFS as an example, a VDT mechanism is usually set up in the UFS, which is mainly used to ensure that the memory chips can operate stably under various operating conditions, and in particular, the performance and reliability can be maintained when there are voltage fluctuations. The VDT mechanism mainly includes the following aspects of detection and tuning:

1. Voltage detection. The VDT mechanism can monitor the supply voltage of the memory chips in real time, to determine whether the supply voltage is within a specified voltage range.

2. Voltage tuning. When the voltage is detected as abnormal, the VDT mechanism can automatically tune the voltage, so as to bring the supply voltage back to the specified voltage range.

The voltage turning can be realized by hardware, firmware or software algorithm. Through the VDT mechanism the memory chips are able to maintain data integrity and stability during voltage fluctuations avoiding data damage or loss due to voltage problem. And the voltage abnormal event usually refers to the supply voltage of the memory chips is outside the specified voltage range. The supply voltage includes at least one of the cutoff supply voltage of the flash memory, the supply voltage of the controller, or the supply voltage of the interface. Taking the supply voltage of the flash memory medium as an example, VCC is responsible for the supply voltage of the flash memory medium, and the specified voltage range is from 2.2 V to 3.6 V. Then, when the supply voltage is outside the voltage range, it indicates that there is a voltage abnormal event.

DME error (DME_ERROR) refers to an error indication defined in the UFS interface standard protocol to indicate an error from the UniPro layer stack to a higher level when an error condition is encountered at the UniPro layer. DME_ERROR can be triggered by the following situations:

1. Link error. DME_ERROR may be triggered when the UniPro layer stack detects an abnormal link status, such as link loss (DME_LINKLOST).

2. Configuration command request error. During the configuration command request process, if the result indicates that an error has occurred, it will also be indicated by DME_ERROR.

3. Control command request error. If the control command request fails, it will also be indicated by DME_ERROR.

4. Attribute operation error. When using primitives such as DME_GET or DME_SET to get or set the attribute, if the operation fails, it will also trigger the DME_ERROR.

5. Power mode change error. When attempting to change the power mode of the M-PHY interface, if the operation fails, DME_ERROR will also be reported.

DME_ERROR is a generic error code that provides feedback on problems encountered by the UFS at the UniPro protocol layer, enabling the host 108 to take appropriate error-handling actions based on the error code, wherein error-handling actions include commands retry, device reset, or more complex troubleshooting processes.

It is noteworthy that the above state abnormal events are only schematic examples, and the examples of the present application do not limit the event types of the state abnormal events detected by the memory system 102.

Reference Clock signal refers to a clock signal that is used for synchronizing operations in an electronic system. In the UFS, the reference clock signal includes at least the following features and functions:

1. The reference clock signal is used to maintain the communication between the host 108 side and the UFS.

2. The host controller provides the reference clock signal to the UFS via the REF_CLK pin.

In some examples, the frequency of the reference clock signal typically includes 19.2 megahertz (MHz), 26 MHZ, 38.4 MHZ, and 52 MHz. In some examples, the host 108 provides the frequency of the reference clock signal to the UFS. In some examples, data transmission between the host 108 and the UFS is performed based on a data transmission rate corresponding to the reference clock signal. In some examples, the data transmission rate between the host 108 and the UFS is obtained by multiplying the reference clock frequency by a specific factor, and a Phase Locked Loop (PLL) is used to achieve a stable and high-frequency reference clock signal.

The reference clock signal in the UFS is a key factor in ensuring data transfer synchronization and system stability, providing the clock reference for the host 108 to operate with the UFS.

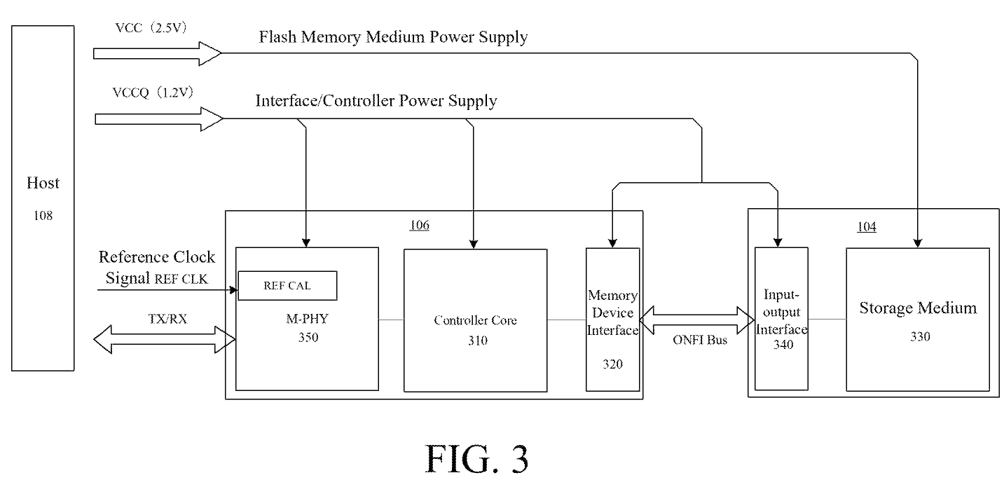

Schematically, as shown in FIG. 3, in conjunction with the system 100 illustrated in FIG. 1 above, the host 108 supplies power to the memory system 102, also, the host 108 provides a reference clock signal (REF CLK) to the memory system 102 such that data transmission (TX/RX) between the host 108 and the memory system 102 is performed based on the data transmission rate (REF CAL) corresponding to the reference clock signal.

The host 108 supplies power to the memory system 102, which includes supplying a VCC voltage that can be realized as a voltage of 2.5V to the flash memory medium, and supplying a VCCQ voltage that can be realized as a voltage of 1.2V to the interface/memory controller 106.

The memory controller 106 comprises a controller core 310 and a memory device interface 320. The memory device 104 comprises a storage medium 330 and an input-output interface 340, wherein the memory device interface 320 comprises the interface configured to control the memory device 104 in the memory controller 106, and the input-output interface 340 comprises the interface configured to realize the input and output of data in a peripheral circuit of the memory device 104.

The controller core 310 transmits data to and from the storage medium 330 via the memory device interface 320 and the input-output interface 340, e.g., the controller core 310 sends data to be written to the storage medium 330 via the memory device interface 320 and the input-output interface 340. The memory device interface 320 comprises an interface in the memory controller 106 for data interaction with the memory device 104, the input-output interface 340 comprises an interface in the memory device 104 for data interaction with the memory controller 106, and in some examples, the input-output interface 340 is an interface in the peripheral circuit in the memory device 104.

In some examples, data transmission between the host 108 and the memory system 102 is realized through the M-PHY interface 350, wherein the M-PHY interface 350 adopts the M-PHY interface standard, which is a physical layer interface standard. M-PHY interface 350 is configured for realizing high-speed data transmission and communication between the host 108 and the memory system 102.

When the host 108 provides the reference clock signal to the memory system 102, it sends the reference clock signal to the M-PHY interface 350, and the M-PHY interface 350 determines a data transmission rate based on the reference clock signal and performs data transmission between the host 108 and the memory system 102 based on the data transmission rate.

In some examples, the data transmission rate depends on the frequency of the reference clock signal and the modulation technique. In some examples, the modulation techniques comprise 8b/10b, or 128b/130b. These modulation techniques allow more data to be transmitted at the same frequency of the reference clock signal. Schematically, in determining the data transmission rate, a modulation ratio is first determined, for example, 8 bits of valid data are transmitted every 10 bits for a modulation ratio of 8b/10b, and 128 bits of valid data are transmitted every 130 bits for a modulation ratio of 128b/130b. After determining the modulation ratio, the valid data transmission rate is calculated by multiplying the reference clock frequency by the proportion of valid data in the modulation ratio. Taking the modulation ratio of 8b/10b as an example, the data transmission rate is equal to the product of the reference clock frequency and the valid data bits over the total data bits, e.g., taking the reference clock frequency as 26 MHz as an example, the data transmission rate is equal to 26×8/10, e.g., 20.8 MHz. For the dual-channel configuration, after doubling the bandwidth, the dual-channel data transmission rate is 41.6 MHz. After considering the coding efficiency, which affects the data transmission rate, taking the coding efficiency of 80% as an example, the dual-channel data transfer rate is 41.6 MHz × 0.8, which is equal to 33.28 MHz. The above data is only a schematic example, and the present example does not limit the specific values.

Since the reference clock signal is a signal provided by the host 108 to the memory system 102, data such as the frequency, phase, amplitude and the like of the reference clock signal are determined from the signal provided by the host 108 to the memory system 102. In the memory system 102, due to external factors such as temperature, radiation, and the like, or operating processes, the reference clock signal behaves differently from the configuration of the host 108, resulting in a signal offset of the reference clock signal. Schematically, the host 108 sends the reference clock signal to the memory system 102 with a configured frequency of 26 MHz, and the reference clock frequency is changed to 52 MHz during the operation of the memory system 102 due to the influence of external factors or operation factors, resulting in signal offset. Therefore, in the examples of the application, the acquired signal offset data indicates the offset status of the reference clock signal, that is, the offset status between a physical manifestation of the reference clock signal and configuration information. In some examples, the physical manifestation of the reference clock signal includes a manifested frequency of the reference clock signal, which is embodied by the phase-locked loop PLL, and the configuration information includes a configuration frequency and is sent by the host 108, wherein the configuration information is configured by the host 108 when it sends the reference clock signal to the memory system 102.

At operation 220, executing an offset processing strategy in response to the signal offset data reaching an offset threshold.

In some examples, the offset processing strategy is preset, alternatively, the offset processing strategy is generated in real time based on the state abnormal event.

In some examples, in response to the signal offset data reaching the offset threshold, an offset processing strategy corresponding to the state abnormal event is executed. That is, different offset processing strategies are executed in case of different identified state abnormal events.

The offset processing strategy is used to deal with the above identified state abnormal events. Alternatively, the offset processing strategy is used to record a signal offset event for the reference clock signal at the time the state abnormal event is generated. The signal offset event comprises a signal gear for the reference clock signal.

In some examples, the memory controller 106 comprises a clock analyzer configured to acquire the signal offset data for the reference clock signal. In some examples, a jitter measurement program runs in the clock analyzer, wherein the jitter measurement program includes at least one of a random jitter measurement program or a deterministic jitter measurement program.

For the first random jitter measurement program, in some examples, the clock analyzer runs a random root mean square (RMS) jitter measurement program, wherein RMS jitter refers to the root mean square value of short-term deviations of the signal relative to an ideal position during transmission. The power spectral density (PSD) of the reference clock signal is displayed via the clock analyzer at a specified integration time. The random RMS jitter measurement program comprises a program for integrating the power spectral density of the reference clock signal over a specific frequency range and calculating the square root value thereof, analyzing periodic variations in the waveform based on the square root value, and calculating random jitter and deterministic jitter of the signal. In some examples, the measured signal offsets are compared to signal quality requirements specified in a standard to determine whether the performance of the reference clock signal meets specifications. It is determined whether the signal offset data for the reference clock signal reaches an offset threshold based on whether the performance of the reference clock signal meets the specifications. In some examples, an offset of the manifested waveform of the reference clock signal relative to the waveform sent by the host 108 is determined based on the square root value as the signal offset data.

For the second deterministic jitter measurement program, it is used to determine deterministic jitter characteristics for the reference clock signal. Timing parameters of the reference clock signal, such as period jitter and duty cycle variations, are displayed via the clock analyzer. The deterministic jitter arises due to variations in the timing parameters of the clock signal, which are typically associated with non-ideal factors in the generation and propagation of the reference clock signal. In some examples, an offset of the manifested waveform of the reference clock signal relative to the waveform sent by the host 108 is determined based on the period jitter and duty cycle variations as the signal offset data.

In some examples, the offset threshold is a preset offset value, and schematically, the offset threshold is 15 picoseconds (ps). When the offset between the reference clock frequency manifested by the reference clock signal and the frequency of the reference clock signal sent by the host 108 is 15 ps, it indicates that the signal offset data has reached the offset threshold.

In other examples, when the reference clock frequency of the reference clock signal sent by the host 108 to the memory system 102 is different, the corresponding offset threshold is different. Schematically, when the reference clock frequency of the reference clock signal sent by the host 108 to the memory system 102 is 19.2 MHz, the corresponding offset threshold is 5.9 ps, e.g., the offset threshold of the reference clock signal is 5.9 ps in the time domain. When the reference clock frequency of the reference clock signal sent by the host 108 to the memory system 102 is 26 MHz, the corresponding offset threshold is 4.6 ps, and when the reference clock frequency of the reference clock signal sent by the host 108 to the memory system 102 is 38.4 MHz, the corresponding offset threshold is 3.5 ps.

The offset determined by the jitter measurement program is compared with the offset threshold corresponding to the reference clock frequency to determine whether the signal offset data reaches the offset threshold.

In summary, the method provided by examples of the present application obtains the signal offset data for the reference clock signal in the case of an unstable operating environment of the memory system, which assists in identifying the current operating stability of the memory system. When the signal offset data for the reference clock signal reaches an offset threshold, it indicates that the operating environment of the memory system is unstable, which will affect the read/write accuracy of the memory system, and therefore an offset processing strategy is executed to improve the operating stability of the memory system.

For different state abnormal events, examples of the present application provide different offset processing strategies. The offset processing strategies corresponding to different state abnormal events are described below.

1. State abnormal event corresponding to operating temperature

In response to the operating temperature of the memory system 102 conforming to a preset temperature requirement, obtaining signal offset data for the reference clock signal, and in response to the signal offset data reaching an offset threshold, adjusting a time interval for sending a feedback signal to the host 108.

1.1 High temperature abnormal event

In some examples, in response to the operating temperature of the memory system 102 reaching a first temperature threshold and the signal offset data reaching the offset threshold, increase the time interval for sending the feedback signal to the host 108.

In some examples, when a high temperature event occurs and the signal offset data for the reference clock signal reaches the offset threshold, the link burden is reduced by increasing the Round-Trip Time (RTT) in order to reduce the pressure on the UniPro layer. The RTT is an important performance metric in computer networks, which indicates the total delay experienced from the time when the data is sent from the sender to the time when the sender receives an acknowledgement from the receiver. In the examples of the present application, the RTT represents the latency between the time when the host 108 sends a data processing request (e.g., a data write request, a data read request, etc.) to the memory system 102 and the time when the memory system 102 sends the feedback signal to the host 108 and the host 108 receives the feedback signal sent by the memory system 102.

In the examples of the present application, the RTT consists of:

1. link propagation time, which is the time required for data to propagate over a physical link, which is related to the length of the link and the speed at which signals propagate over the link;

2. processing time of the memory system 102, which is the time for processing data processing requests sent by the host 108 at the host 108 and the memory system 102, including the time for receiving, processing the data, and the time for sending the acknowledgement;

3. caching and queuing time at intermediate nodes of the network, which is the time that a data packet waits to be processed in a router or switch in the network, which may vary depending on the level of network congestion.

RTT is one of the most important metrics of network transmission performance which can reflect the speed and stability of data transmission in the network. Typically the shorter the RTT, the faster the network transmission and vice versa.

In the examples of the present application, when a high temperature event occurs and the signal offset data for the reference clock signal reaches an offset threshold, it is necessary to slow down the frequency of sending and receiving data by the memory system 102. Therefore, after the memory system 102 receives the data processing request sent by the host 108 and processes the data processing request, it will not immediately send a feedback signal to the host 108. Alternatively, instead of sending the feedback signal to the host 108 at a preset time interval, the feedback signal will be sent to the host 108 at an extended time interval based on the preset time interval.

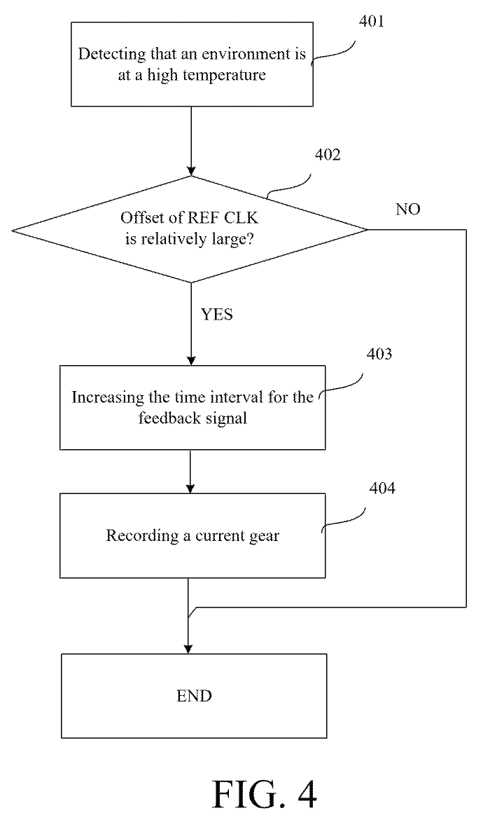

Schematically, FIG. 4 is a flowchart of a method for controlling a memory system in a high temperature situation provided by an example of the present application. As shown in FIG. 4, the process comprises following operations.

At operation 401: detecting that the environment is at a high temperature.

In some examples, the memory system 102 comprises a temperature sensor connected to the memory controller 106 and configured to collect the operating temperature of the memory system 102. The temperature sensor is configured to collect the operating temperature of the memory system 102 during operation and to acquire operating temperature data.

In some examples, the temperature sensor is connected to a peripheral circuit in the memory device 104. After the operating temperature is collected by the temperature sensor, the operating temperature is sent to the memory controller 106 through the peripheral circuit, and the memory controller 106 determines whether the operating temperature reaches the first temperature threshold.

The collected operating temperature is compared with the preset first temperature threshold, and if the operating temperature reaches the first temperature threshold, it indicates that the operating temperature of the memory system 102 is higher, that is, it is identified that the operating environment of the memory system 102 is in a high temperature state. On the contrary, if the collected operating temperature does not reach the first temperature threshold, it indicates that the operating temperature of the memory system 102 is not in a high temperature state.

The memory controller 106 compares the collected operating temperature with a preset first temperature threshold, and determines whether the operating temperature reaches the first temperature threshold.

At operation 402, determining whether the offset of the reference clock signal is relatively large.

The signal offset data for the reference clock signal is acquired, and when the signal offset data reaches the offset threshold, it is determined that the offset of the reference clock signal is relatively large.

The memory controller 106 acquires the signal offset data for the reference clock signal, and decides determines the signal offset data reaches the offset threshold.

At operation 403, if the offset of the reference clock signal is relatively large, increasing the time interval for the feedback signal.

When it is detected that the environment is at the high temperature and the offset of the reference clock signal is relatively large, it is determined that the load of the memory system 102 is too high, therefore, the time interval for the feedback signal is increased. Schematically, before detecting that the environment is at the high temperature, the memory system 102 sends the feedback signal to the host 108 at a first time interval after receiving the data processing request sent by the host 108, and the host 108 continues to send the data processing request to the memory system 102 after receiving the feedback signal. Upon detecting that the environment is at the high temperature and the offset of the reference clock signal is relatively large, the memory controller 106 determines a second time interval after the memory system 102 receives the data processing request sent by the host 108, and the feedback signal is sent to the host 108 at the second time interval, wherein the first time interval is less than the second time interval.

At operation 404, recording a current gear.

Recording the current gear refers to recording a gear of the most recent reference clock signal sent by the host 108 to the memory system 102 prior to the current moment, which comprises a reference clock frequency of the most recent reference clock signal sent by the host 108 to the memory system 102.

In summary, the method provided in the present example reduces the pressure on the UniPro layer and reduces the link burden by increasing the feedback interval for the feedback signal when the memory system is operating at a high temperature and the signal offset data for the reference clock signal reaches an offset threshold.

1.2 Low temperature Abnormal Event

In some examples, in response to the operating temperature of the memory system 102 being less than the second temperature threshold and the signal offset data being less than the offset threshold, decrease the time interval for sending the feedback signal to the host 108, wherein the second temperature threshold is less than the first temperature threshold.

The memory controller 106 compares the collected operating temperature with a preset second temperature threshold, and determines whether the operating temperature is less than the second temperature threshold.

In some examples, when the low temperature event occurs and the reference clock signal does not have a relatively large offset, the RTT may be decreased and the high power consumption operation may be increased to increase the device service hours of the memory system 102 with the residual temperature.

In the examples of the present application, when the low temperature event occurs and the signal offset data for the reference clock signal does not reach the offset threshold, it is necessary to increase the frequency of sending and receiving the data on the side of the memory system 102. Therefore, after the memory system 102 receives the data processing request sent by the host 108 and processes the data processing request, it sends the feedback signal to the host 108 at a reduced time interval based on the preset time interval.

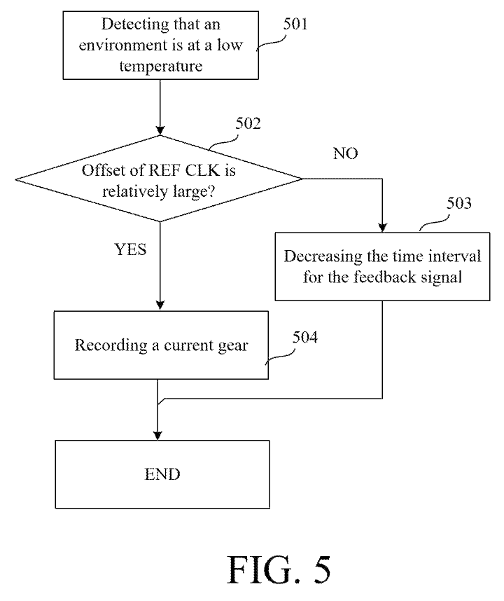

Schematically, FIG. 5 is a flowchart of a method for controlling a memory system 102 in a low temperature situation provided by an example of the present application. As shown in FIG. 5, the process comprises following operations.

At operation 510, detecting that the environment is at a low temperature.

In some examples, the temperature sensor is configured to collect the operating temperature of the memory system 102 during operation and to acquire operating temperature data.

In some examples, the temperature sensor is connected to the memory controller 106 or a peripheral circuit in the memory device 104. After the operating temperature is collected by the temperature sensor, the operating temperature is sent to the memory controller 106 through the peripheral circuit, and the memory controller 106 determines whether the operating temperature reaches the first temperature threshold.

The collected operating temperature is compared with the preset second temperature threshold, and if the operating temperature is less than the second temperature threshold, it indicates that the operating temperature of the memory system 102 is lower, that is, it is identified that the operating environment of the memory system 102 is in a low temperature state (operation 501). On the contrary, if the collected operating temperature reaches the second temperature threshold, it indicates that the operating temperature of the memory system 102 is not in a low temperature state.

At operation 502, determining whether the offset of the reference clock signal is relatively large.

The signal offset data for the reference clock signal is acquired, and when the signal offset data reaches the offset threshold, it is determined that the offset of the reference clock signal is relatively large. Otherwise, if the signal offset data does not reach the offset threshold, it is determined that the offset of the reference clock signal is relatively small.

At operation 503, if the offset of the reference clock signal is relatively small, decreasing the time interval for the feedback signal.

When it is detected that the environment is at the low temperature and the offset of the reference clock signal is relatively small, it is determined that the load of the memory system 102 is relatively low, therefore, the time interval for the feedback signal is decreased. Schematically, before detecting that the environment is at the low temperature, the memory system 102 sends the feedback signal to the host 108 at a first time interval after receiving the data processing request sent by the host 108, and the host 108 continues to send the data processing request to the memory system 102 after receiving the feedback signal. Upon detecting that the environment is at the low temperature and the offset of the reference clock signal is relatively small, the memory controller 106 determines a third time interval after the memory system 102 receives the data processing request sent by the host 108, and the feedback signal is sent to the host 108 at the third time interval, wherein the first time interval is larger than the third time interval.

In some examples, in response to the operating temperature of the memory system 102 being less than the second temperature threshold, the memory system 102 is controlled to perform a power consumption operation, wherein the power consumption operation is to control the memory system 102 to generate additional power consumption based on power consumption of read-write operations.

In some examples, the power consumption operation comprises at least one of a read-write operation, a garbage collection (GC) operation, a wear leveling operation, an erase operation, or an inspection operation.

The garbage collection operation is a memory management mechanism for identifying and collecting memory space occupied by objects that are no longer in use in the program, thereby preventing memory leakage and improving the efficiency of memory usage.

The wear leveling operation is a management strategy for the memory system 102 to extend the life of the storage medium 330 in the memory device 104. Since each memory cell has a limited number of erase/write cycles, without wear leveling, frequent writes may cause the memory cell to fail prematurely while other memory cells are underused. In some examples, the wear leveling operation is implemented by a wear leveling algorithm, which includes static wear leveling and dynamic wear leveling. Static wear leveling refers to evenly distributing all erase and write operations to all memory blocks. Dynamic wear leveling refers to dynamically distributing erase and write operations based on the actual usage of each memory block to ensure that all blocks are worn as evenly as possible.

The inspection operation refers to a process of performing periodic inspections of the memory system 102 to detect and repair errors. Such operations are critical to ensure data integrity and reliability. Schematically, the inspection operation includes reading data written in the memory device 104 and testing the data for errors or, alternatively, verifying the data written in the memory device 104 through mechanisms such as ECC, CRC, parity check, and the like.

At operation 504, if the offset of the reference clock signal is relatively large, recording a current gear.

Recording the current gear refers to recording a gear of the most recent reference clock signal sent by the host 108 to the memory system 102 prior to the current moment, which comprises a reference clock frequency of the most recent reference clock signal sent by the host 108 to the memory system 102.

In conclusion, the present example provides a method for increasing the data processing load of the memory system and increasing the operating temperature of the memory system 102 by decreasing the feedback interval of the feedback signal when the operation of the memory system is in a low-temperature environment and the signal offset data for the reference clock signal does not reach the offset threshold.

### 2. Hardware Reset Event

Acquiring the signal offset data for the reference clock signal in response to a hardware reset event, and increasing a latency for hardware initialization of the hardware reset event in response to the signal offset data reaching the offset threshold.

In some examples, in response to the hardware reset event occurs during the operation of the memory system 102 and the signal offset data for the reference clock signal reaching the offset threshold, the latency for hardware initialization of the hardware reset event in response to the signal offset data reaching the offset threshold is increased.

In some examples, the increasing the latency for hardware initialization of the hardware reset event is realized by adding an initialization operation during the hardware initialization, wherein the initialization operation comprises at least one of a hardware self-test operation or a firmware checking operation.

In some examples, the hardware reset event may be generated due to a user-initiated request for a hardware reset, or it may be caused by a power supply or system abnormality. The process of hardware reset puts a greater pressure on the demand for power supply, so in the case of generating the hardware reset event, the signal offset data for the reference clock signal is detected, and in the case of the signal offset for the reference clock signal is relatively large, the latency for hardware initialization of the hardware reset event is extended, to ensure that the memory system 102 is able to complete the hardware reset in a stable manner.

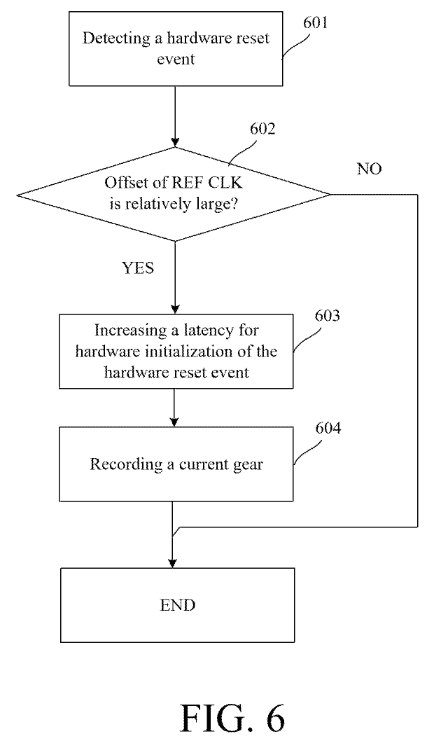

Schematically, FIG. 6 is a flowchart of a method for controlling a memory system based on hardware reset provided by an example of the present application. As shown in FIG. 6, the process comprises following operations.

At operation 601, detecting a hardware reset event.

In some examples, in response to detecting the hardware reset signal, it is determined that the hardware reset event occurs in the memory system 102; alternatively, it is determined via a status register whether the hardware reset event occurs in the memory system 102.

In some examples, the manner of detecting the hardware reset event includes at least one of the following:

1. Reset pin detection. In some examples, a reset pin (e.g., RESET pin) of the memory controller 106 is directly connected to a reset circuit, and the hardware reset event can be detected by monitoring a change in state of the reset pin. For example, a level change of the reset pin is monitored, and when the level of the reset pin matches a level characteristic corresponding to the hardware reset signal, it is determined that the hardware reset event is detected.

2. State register detection. In some examples, the memory controller 106 sets a specified status register or flag bit upon reset. The status of the register or flag bit is acquired at reset initiation of the memory system 102 to determine whether a hardware reset event has occurred.

3. External reset circuit detection. In some examples, the reset signal is detected by designing an external circuit. For example, a comparator or logic gate circuit can be used to detect a change in state of the reset pin and generate an interrupt signal or log the event.

It should be noted that, the above ways of detecting a hardware reset event are only schematic examples and are not limited by examples of the present application.

At operation 602, determining whether the offset of the reference clock signal is relatively large.

The signal offset data for the reference clock signal is acquired, and when the signal offset data reaches the offset threshold, it is determined that the offset of the reference clock signal is relatively large. Otherwise, if the signal offset data does not reach the offset threshold, it is determined that the offset of the reference clock signal is relatively small.

At operation 603, increasing a latency for hardware initialization of the hardware reset event when the offset of the reference clock signal is relatively large.

In some examples, the increasing the latency for hardware initialization of the hardware reset event is realized by adding an initialization operation during the hardware initialization, wherein the initialization operation comprises at least one of a hardware self-test operation or a firmware checking operation.

The hardware self-test operation is an operation used in the hardware reset process to check the status and functionality of hardware components in the memory system 102, and the hardware self-test operation includes at least one of the following self-test items:

1. Processor self-test of the memory controller 106. It verifies whether the processor is working properly, usually by performing simple instruction set tests (e.g., addition, logic operations, etc.) to confirm the basic functions of the processor. The processor's status and control registers are checked to ensure that the status and control registers are in the expected state.

2. Storage medium 330 test. In some examples, access the memory addresses one by one to check whether data can be read and written correctly.

3. ECC check. Check the ECC bits in memory to ensure data integrity.

4. Check whether the power supply voltage is within the normal range to ensure that the memory system 102 can operate stably.

5. Check the operating temperature of the memory system 102 to ensure that no overheating occurs.

The firmware checking operation is an operation in the hardware reset process used to verify the integrity and validity of the firmware. The firmware checking operation includes at least one of the following checking items:

1. Check by checksum. Calculate a checksum of the firmware and comparing it with a pre-stored value stored in the firmware, and determine whether the firmware is corrupted based on the result of the comparison of the checksum.

2. Check by hash. Calculate a hash value of the firmware by using a hash algorithm and comparing it with a pre-stored hash value, and determine the integrity of the firmware based on the result of the comparison of the hash value.

3. Check by digital signature. In some example, in the case where the firmware is protected with a digital signature, verify the validity of the digital signature so as to check the firmware.

In some examples, n initialization operations are used to complete the hardware reset process when the offset of the reference clock signal is determined to be small, and m initialization operations are used to complete the hardware reset process when the offset of the reference clock signal is determined to be large, wherein n and m are positive integers and n<m.

At operation 604, recording a current gear.

Recording the current gear refers to recording a gear of the most recent reference clock signal sent by the host 108 to the memory system 102 prior to the current moment, which comprises a reference clock frequency of the most recent reference clock signal sent by the host 108 to the memory system 102.

In summary, in the method provided in this example, in the case where a hardware reset event occurs in the memory system and the signal offset data of the reference clock signal reaches the offset threshold, it is indicated that the stability of the hardware reset process is low, so an initialization operation is added during the hardware initialization to improve the stability of the startup of the memory system 102.

### 3. Voltage abnormal event

Acquiring the signal offset data for the reference clock signal in response to a voltage abnormal event, and executing a recovery processing flow for device management entity (DME) errors in response to the signal offset data reaching the offset threshold.

In some examples, executing a recovery processing flow for the DME errors in response to a voltage abnormal event occurring during operation of the memory system 102, and the signal offset data for the reference clock signal reaching an offset threshold.

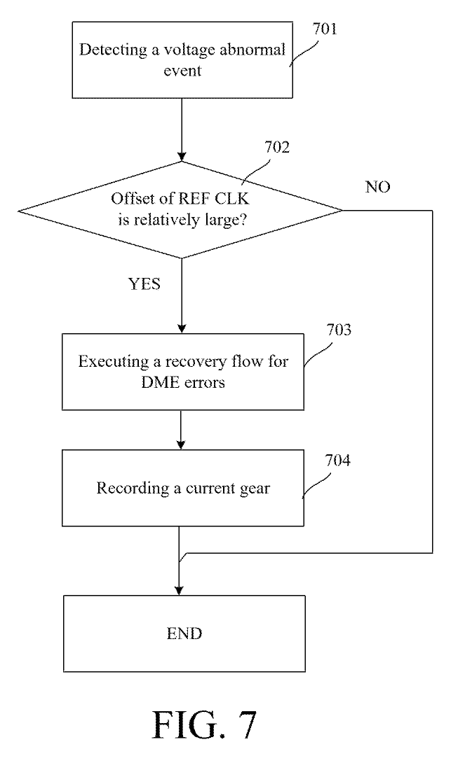

Schematically, FIG. 7 is a flowchart of a method for controlling a memory system in a voltage abnormal event provided by an example of the present application. As shown in FIG. 7, the process comprises following operations.

At operation 701: detecting a voltage abnormal event.

In some examples, the operating voltage of the memory system 102 is detected by a voltage sensor or, alternatively, the operating voltage of the memory system 102 is monitored in real time by a voltage detection integrated circuit. In some examples, the memory system 102 operates with overvoltage (OV) and undervoltage (UV) thresholds set, wherein the overvoltage and undervoltage thresholds are determined based on the rated voltage of the memory system 102.

In some examples, a comparator circuit (e.g., an operational amplifier) is used to compare the voltage detected by the voltage sensor to the set overvoltage and undervoltage thresholds. When the detected voltage exceeds the overvoltage threshold or falls below the undervoltage threshold, the comparator outputs a corresponding signal. In some examples, the output signal of the comparator is processed by a logic circuit to determine whether a voltage abnormal event has occurred.

At operation 702, determining whether the offset of the reference clock signal is relatively large.

The signal offset data for the reference clock signal is acquired, and when the signal offset data reaches the offset threshold, it is determined that the offset of the reference clock signal is relatively large. Otherwise, if the signal offset data does not reach the offset threshold, it is determined that the offset of the reference clock signal is relatively small.

At operation 703: executing the recovery processing flow for DME errors when the offset of the reference clock signal is relatively large.

The recovery processing flow for DME errors mainly comprises the following process:

1. Error detection. In some examples, the DME continuously detects the state and operation of the device, and if an abnormality or an error is detected, the DME records the error information and sends an error report to the memory system 102 via a status register or an interrupt signal, wherein the error report includes an error code and error-related information.

2. Error classification. That is, identifying the type of the error based on relevant information such as the error code and the like, such as: hardware failure, software configuration error, timeout error, and so on.

At operation 704, recording a current gear.

Recording the current gear refers to recording a gear of the most recent reference clock signal sent by the host 108 to the memory system 102 prior to the current moment, which comprises a reference clock frequency of the most recent reference clock signal sent by the host 108 to the memory system 102.

In summary, the method provided in the present example improves the stability of the startup of the memory system 102 by executing a recovery process for DME errors when a voltage abnormal event occurs in the memory system 102 and the signal offset data for the reference clock signal reaches an offset threshold.

### 4. DME Error Event

Acquiring the signal offset data for the reference clock signal in response to the number of the device management entity (DME) errors reaching a number threshold, and recording a signal offset event of the reference clock signal in response to the signal offset data reaching the offset threshold.

In some examples, the signal offset event of the reference clock signal is recorded in response to the number of DME errors during operation of the memory system 102 reaching the number threshold and the signal offset data for the reference clock signal reaching the offset threshold, wherein the number threshold is a preset value for determining whether the number of DME errors is excessive.

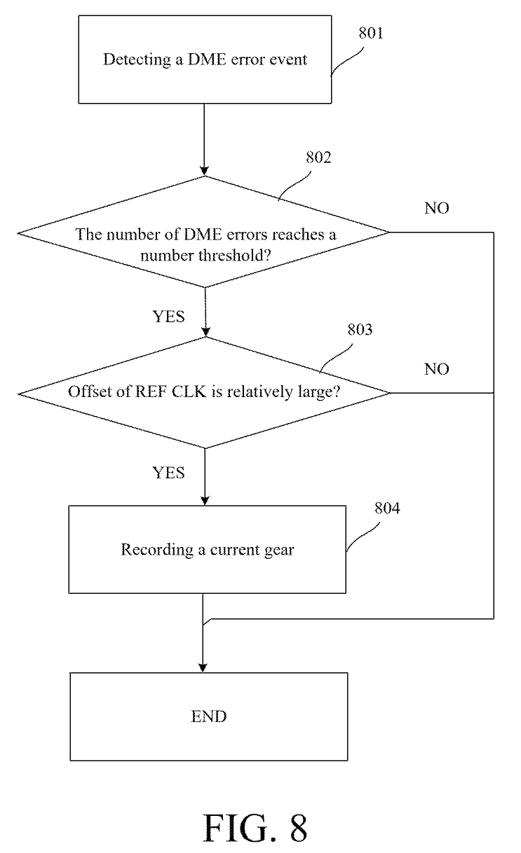

Schematically, FIG. 8 is a flowchart of a method for controlling a memory system based on device management entity errors provided by an example of the present application. As shown in FIG. 8, the process comprises following operations.

At operation 801, detecting a DME error event.

Error detection. In some examples, the DME continuously detects the state and operation of the device, and if an abnormality or an error is detected, the DME records the error information and sends an error report to the memory system 102 via a status register or an interrupt signal.

In some examples, the number of DME error events are counted over a predetermined length of time, e.g., the number of occurrences of the DME error events are counted within a first length of time prior to the current moment. In some examples, the DME is preconfigured with state data and operation information for the abnormal operation of the device when detecting the state and operation of the device, and when the detected state and operation match the state data and operation information for the abnormal operation of the device, it is determined that the device is operating abnormally and generates a DME error event.

In some examples, a counter is included in the memory system 102, and when the DME detects that an abnormal event occurs during the operation of the memory system 102, it determines that a DME error event exists and sends a counting signal to the counter, and the counter performs a plus one operation according to the counting signal, thereby realizing counting of the number of DME error events.

At operation 802, determining whether the number of DME errors reaches a number threshold.

In some examples, the memory system 102 is pre-set with a number threshold corresponding to the number of DME errors, wherein determining whether the number of DME errors reaches the number threshold is performed in at least one of the following timings:

First, determine whether the number of DME errors reaches the number threshold periodically. That is, a period for determine the number of DME errors is set, and the number of DME errors counted by the counter is obtained in accordance with the determined period.

Second, in response to a change in the count of the counter, the number of DME errors counted by the counter is obtained, and is compared with the number threshold to determine whether the number of DME errors reaches the number threshold.

At operation 803, when the number of DME errors reaches a number threshold, determining whether the offset of the reference clock signal is relatively large.

In some examples, when the number of DME errors is greater than or equal to the number threshold, it is determined that whether the offset of the reference clock signal reaches the offset threshold.

The signal offset data for the reference clock signal is acquired, and when the signal offset data reaches the offset threshold, it is determined that the offset of the reference clock signal is relatively large. Otherwise, if the signal offset data does not reach the offset threshold, it is determined that the offset of the reference clock signal is relatively small.

At operation 804, if the offset of the reference clock signal is relatively large, recording a current gear.

Recording the current gear refers to recording a gear of the most recent reference clock signal sent by the host 108 to the memory system 102 prior to the current moment, which comprises a reference clock frequency of the most recent reference clock signal sent by the host 108 to the memory system 102.

In some examples, when the offset of the reference clock signal is relatively large and the number of DME errors reaches the number threshold, it is indicated that the operation process of the memory system 102 is weakly stable, and in some examples the memory system 102 is triggered to perform a hardware reset operation.

In summary, in the method provided in the present example, in the case where the number of DME errors generated in the memory system reaches the number threshold and the signal offset data for the reference clock signal reaches the offset threshold, the stability of the operation of the memory system is improved by recording the gearing information of the reference clock signal as log data for the subsequent reference information for analyzing the abnormality of the operation of the memory system.

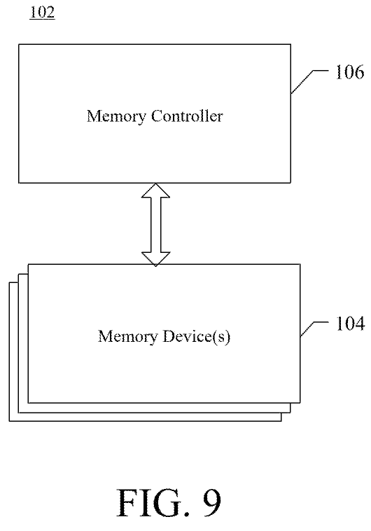

FIG. 9 is a schematic diagram of a structure of a memory system provided by an example of the present application. As shown in FIG. 9, the memory system 102 comprises a memory device 104 and a memory controller 106.

In some examples, the memory controller 106 is configured to: acquire signal offset data for a reference clock signal in response to identifying a state abnormal event, wherein the signal offset data indicates an offset status of the reference clock signal; and execute an offset processing strategy in response to the signal offset data reaching an offset threshold.

In some examples, the signal offset data indicates an offset status between a physical manifestation of the reference clock signal and configuration information; and the physical manifestation comprises a manifested frequency of the reference clock signal, and the configuration information comprises a configuration frequency and is sent by a host 108.

In some examples, the memory controller 106 is further configured to:

execute an offset processing strategy corresponding to the state abnormal event in response to the signal offset data reaching the offset threshold.

In some examples, the memory controller 106 is further configured to:

acquire the signal offset data for the reference clock signal in response to an operating temperature of the memory system meeting a preset temperature requirement; and

adjust a time interval for sending a feedback signal to a host 108 in response to the signal offset data reaching the offset threshold.

In some examples, the memory controller 106 is further configured to:

increase the time interval for sending the feedback signal to the host 108 in response to the operating temperature of the memory system reaching a first temperature threshold and the signal offset data reaching the offset threshold.

In some examples, the memory controller 106 is further configured to:

decrease the time interval for sending the feedback signal to the host 108 in response to the operating temperature of the memory system being less than a second temperature threshold and the signal offset data being less than the offset threshold, wherein the second temperature threshold is less than the first temperature threshold.

In some examples, the memory controller 106 is further configured to:

control the memory system to execute a power consumption operation in response to the operating temperature of the memory system being less than the second temperature threshold, wherein the power consumption operation is to control the memory system to generate additional power consumption based on power consumption of read-write operations.

In some examples, the memory controller 106 is further configured to:

acquire the signal offset data for the reference clock signal in response to a hardware reset event; and

increase a latency for hardware initialization of the hardware reset event in response to the signal offset data reaching the offset threshold.

In some examples, the memory controller 106 is further configured to:

add an initialization operation during the hardware initialization in response to the signal offset data reaching the offset threshold, wherein the initialization operation comprises at least one of a hardware self-test operation or a firmware checking operation.

In some examples, the memory controller 106 is further configured to:

acquire the signal offset data for the reference clock signal in response to a voltage abnormal event; and

execute a recovery processing flow for device management entity (DME) errors in response to the signal offset data reaching the offset threshold.

In some examples, the memory controller 106 is further configured to:

acquire the signal offset data for the reference clock signal in response to the number of device management entity (DME) errors reaching a number threshold; and

record a signal offset event of the reference clock signal in response to the signal offset data reaching the offset threshold.

In some examples, the memory controller 106 comprises a clock analyzer, wherein

the clock analyzer is configured to acquire the signal offset data for the reference clock signal.

In some examples, the memory controller 106 is further configured to:

record a signal offset event of the reference clock signal in response to the signal offset data reaching the offset threshold.

In some examples, the signal offset event comprises a signal gear for the reference clock signal.

In some examples, the memory system 102 comprises a universal flash memory (UFS).

According to the memory system provided by the examples of the present application, when the operating environment of the memory system is unstable, the signal offset data for the reference clock signal is acquired, and the current operating stability condition of the memory system is identified with assistant of the signal offset data. When the signal offset data for the reference clock signal reaches the offset threshold, it means that the operating environment of the memory system is unstable, which will affect the read/write accuracy of the memory system. Therefore, the offset processing strategy is executed to improve the operating stability of the memory system.

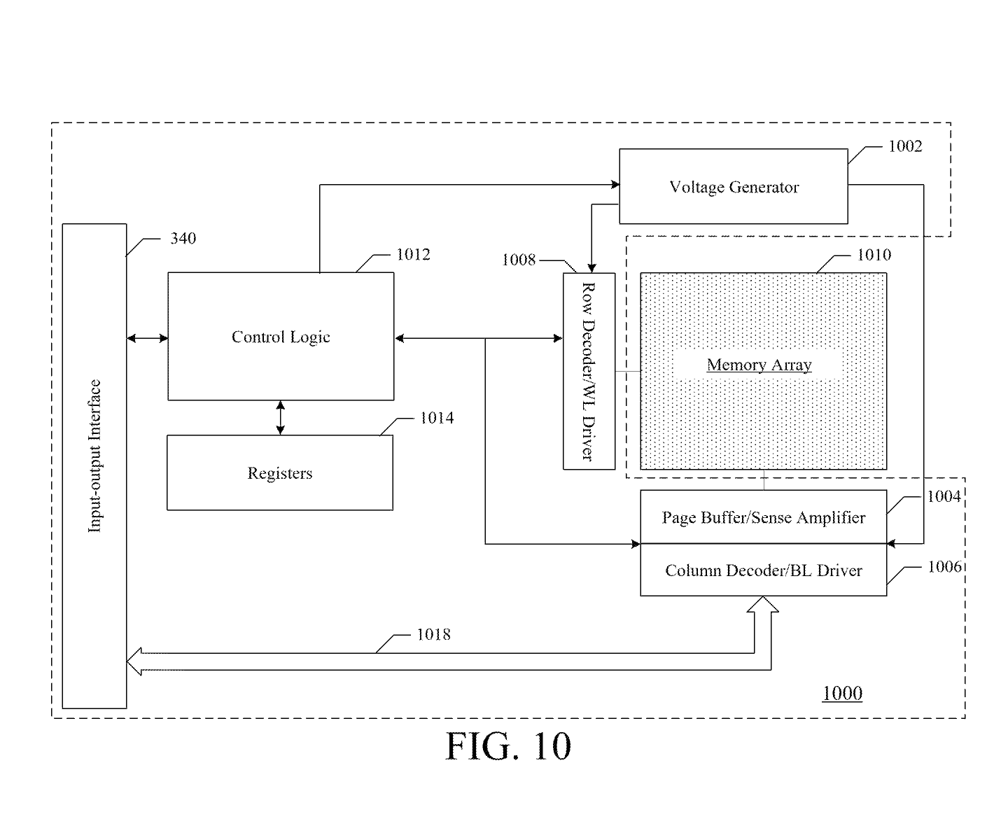

FIG. 10 is a schematic diagram of a structure of a memory device 104 provided by an example of the present application. As shown in FIG. 10, the memory device 104 comprises a peripheral circuit 1000 and a memory array 1010.

The peripheral circuit 1000 is configured to write data into the memory array 1010 and read data from the memory array 1010.

The peripheral circuit 1000 comprises a voltage generator 1002, a page buffer/sense amplifier 1004, a column decoder/bit line (BL) driver 1006, a row decoder/word line (WL) driver 1008, control logic 1012, registers 1014, an input-output interface 340, and a data bus 1018. It should be understood that in some examples, additional peripheral circuits not shown in FIG. 10 may also be included.

The page buffer/sense amplifier 1004 may be configured to read data from and program (write) data to the memory array 1010 according to control signals from the control logic 1012. In one example, the page buffer/sense amplifier 1004 may store a page of programming data (write data) to be programmed into one page of the memory array 1010. In another example, the page buffer/sense amplifier 1004 may execute a program verify operation to ensure that data has been correctly programmed into the memory cells coupled to the selected word line. In yet another example, the page buffer/sense amplifier 1004 may also sense a low power signal from the bit line representing a data bit stored in the memory cell, and amplify the small voltage swing to an identifiable logic level in a read operation.

Column decoder/bit line driver 1006 may be configured to be controlled by control logic 1012 and select one or more NAND memory strings by applying bit line voltages generated from the voltage generator 1002.

The row decoder/word line driver 1008 may be configured to be controlled by the control logic 1012 and select/deselect blocks of the memory array 1010 and select/deselect the word lines of the block. The row decoder/word line driver 1008 may also be configured to drive a word line using the word line voltage (V_{WL}) generated from the voltage generator 1002. In some examples, the row decoder/word line driver 1008 may also select/deselect and drive the source select gate line and the drain select gate line. Schematically, the row decoder/word line driver 1008 is configured to execute erase operations on memory cells coupled to the selected word line(s).

The voltage generator 1002 may be configured to be controlled by the control logic 1012 and generate word line voltages (e.g., read voltages, program voltages, pass voltages, local voltages, verify voltages, etc.), bit line voltages, and source line voltages to be supplied to the memory array 1010.

Control logic 1012 may be coupled to other components of each peripheral circuit described above and configured to control operation of other components of each peripheral circuit.

Registers 1014 may be coupled to control logic 1012 and include state registers, command registers, and address registers for storing state information, command OP codes, and command addresses for controlling operations of each peripheral circuit. The input-output interface 340 may be coupled to control logic 1012 and act as a control buffer to buffer and relay control commands received from a host (not shown) to control logic 1012, and buffer and relay state information received from control logic 1012 to the host. The input-output interface 340 may also be coupled to the column decoder/bit line driver 1006 via a data bus 1018 and act as a data input-output interface and a data buffer to buffer and relay data to or from the memory array 1010.

In some examples, with reference to the memory device 104 shown in FIG. 3, the memory device 104 shown in FIG. 3 includes an input-output interface 340 and a storage medium 330, wherein the storage medium 330 includes portions of the memory device 104 other than the input-output interface 340 as illustrated in FIG. 10. As shown in the memory device 104 illustrated in FIG. 10, the storage medium 330 includes, but is not limited to, a voltage generator 1002, a page buffer/sense amplifier 1004, a column decoder/BL driver 1006, a row decoder/WL driver 1008, a memory array 1010, control logic 1012, registers 1014, and a data bus 1018.

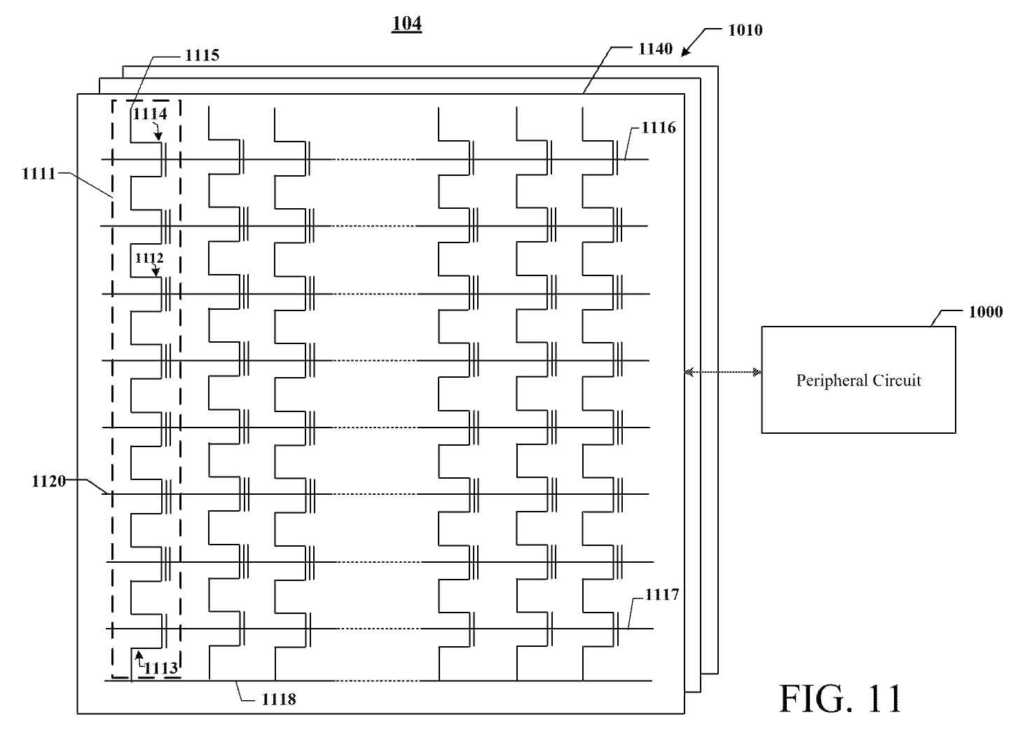

FIG. 11 is a schematic diagram of a memory device 104 provided by an example of the present application. As shown in FIG. 11, the memory device 104 comprises:

a memory array 1010 comprising a plurality rows of memory cells;

a plurality of word lines 1120 each coupled to the plurality rows of memory cells;

a peripheral circuit 1000 coupled to the plurality of word lines 1120 and configured to perform operations such as programming (e.g., write data) or read data on selected rows of memory cells of the plurality rows of memory cells, wherein the selected rows of memory cells are rows of memory cells to which the selected word lines are coupled for performing operations such as programming or read data.

The memory array 1010 may comprise a NAND memory array. The NAND memory array comprises a plurality of memory strings 1111 arranged in an array, wherein each memory string 1111 extends vertically above a substrate (not shown). In some examples, each memory string 1111 comprises a plurality of memory cells 1112 coupled in series and vertically stacked.

As shown in FIG. 11, each memory string 1111 may further comprise a Source Select Gate (SSG) 1113 at the bottom and a Drain Select Gate (DSG) 1114 at the top. The source select gate is also referred to as a lower select transistor, a Bottom Select Gate (BSG), or a source select transistor, and the drain select gate is also referred to as an upper select transistor, a Top Select Gate (TSG), or a drain select transistor. The source select gate 1113 and the drain select gate 1114 may be configured to activate the selected memory string 1111 during read and program operations.

In some examples, the drain select gate 1114 of each memory string 1111 is coupled to a respective bit line 1115, and data may be read or written from the bit line 1115 via an output bus (not shown).

In some examples, each memory string 1111 is configured to apply a select voltage (e.g., higher than a threshold voltage of a transistor having a drain select gate 1114) or a deselect voltage (e.g., 0V) to a respective drain select gate 1114 through one or more DSG lines 1116. Alternatively, in some examples, each memory string 1111 is configured to be selected or deselected by applying a select voltage (e.g., higher than a threshold voltage of a transistor having a source select gate 1113) or a deselect voltage (e.g., 0V) to a respective source select gate 1113 through one or more SSG lines 1117.

As shown in FIG. 11, the memory string 1111 may be organized into a plurality of blocks 1140, any one of which may have a Source Line (SL) 1118, and the sources of all memory strings 1111 in the block 1140 being coupled through the source line 1118, which is also referred to as a common source line or an Array Common Source (ACS).

The source line 1118 may be configured to be grounded, so as to subsequently ground the source of each memory cell of the memory string in the block 1140 in some operations. In some examples, in some other operations, the source of each memory cell of the memory string in the block 1140 may also be connected to a high voltage through the source line 1118.

Each block 1140 is a basic data unit for an erase operation, that is, all memory cells 1112 on the same block 1140 are simultaneously erased. To erase the memory cells 1112 in the selected block, the source lines coupled to the selected block may be biased with an erase voltage (Vers), such as a high positive voltage (20 V or higher).

It should be understood that in other examples, the erase operation may be performed at a half block level, at a quarter block level, or any suitable number of blocks or at any suitable fractional level of blocks.

As shown in FIG. 11, the same layer of memory cells 1112 of adjacent memory strings 1111 in the same block 1140 may be coupled via word lines 1120, which are used for selecting which layer of the memory cells 1112 in the block 1140 is affected by read and program operations.

In some examples, each word line 1120 is coupled to a page to which the memory cell 1112 belongs, and the page is a basic data unit for a program operation. The size of the page may be related to the number of memory strings 1111 coupled via the word line 1120 in one block 1140. Each word line 1120 may be coupled on a control gate (e.g., gate electrode) of each memory cell 1112 in a respective page. It can be understood that one row of memory cells is a plurality of memory cells 1112 located on the same page.

It should be noted that the same layer of memory cells in one block 1140 corresponds to the same word line, but the same layer of memory cells may be divided into one or more pages. That is, one word line may be coupled to one or more pages.

Peripheral circuit 1000 may be coupled to memory array 1010 through bit lines 1115, word lines 1120, source lines 1118, SSG lines 1117, and DSG lines 1116. Peripheral circuit 1000 may include any suitable analog, digital, and mixed-signal circuit for facilitating operation of memory array 1010 by at least one of applying voltage signals to memory cells 1112 or sensing current signals from memory cells 1112 via bit line 1115, word line 1120, source line 1118, SSG line 1117, and DSG line 1116.

The above description of the related hardware examples of the memory device has the beneficial effects similar to those of the foregoing method examples. For technical details not disclosed in the related hardware examples of the memory device, please refer to the description of the method examples of the present application for understanding.

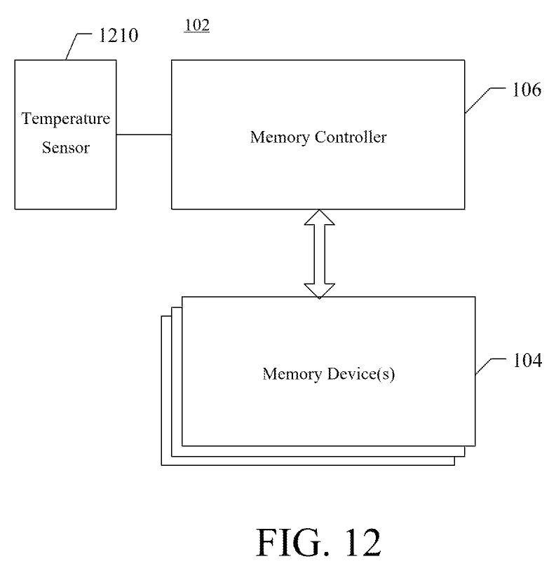

FIG. 12 is a schematic diagram of a structure of a memory system 102 provided by an example of the present application. As shown in FIG. 12, the memory system 102 comprises a memory controller 106, one or more memory devices 104 and a temperature sensor 1210.

The temperature sensor 1210 is configured to collect the environment temperature, wherein the temperature data collected by the temperature sensor 1210 may be transmitted to the peripheral circuit 1000 of the memory device 104, for example, the temperature data collected by the temperature sensor 1210 may be transmitted to the control logic 1012 in the peripheral circuit 1000; or the temperature data collected by the temperature sensor 1210 may also be transmitted to the memory controller 106. The temperature sensor 1210 is illustrated in FIG. 12 as an example of a temperature sensor 1210 being connected to the memory controller 106 and transmitting temperature data to the memory controller 106, and the temperature sensor 1210 illustrated in FIG. 12 may also be connected to the memory device 104, e.g., to the control logic 1012 of the peripheral circuit 1000 in the memory device 104, or the temperature sensor 1210 may also be connected to both the memory controller 106 as well as the memory device 104, and the examples of the present application do not limit the manner in which the temperature sensor 1210 may be connected in the memory system 102.

In some examples, the temperature sensor 1210 may be disposed on the memory device 104, for example, the temperature sensor 1210 may be integrated on the same wafer as the peripheral circuit 1000 of the memory device 104; or, the temperature sensor 1210 may be disposed on a Printed Circuit Board (PCB) together with the memory device 104 and the memory controller 106.

In the examples of the present application, when the temperature data collected by the temperature sensor 1210 is transmitted to the control logic 1012 of the memory device 104, the control logic 1012 sends the temperature data to the memory controller 106 through the input-output interface 340, and the memory controller 106 determines whether the temperature data is a high temperature or a low temperature. Alternatively, the control logic 1012 determines whether the temperature data is a high temperature or a low temperature, and sends the determination result to the memory controller 106. When the temperature data collected by the temperature sensor 1210 is transmitted to the memory controller 106, the memory controller 106 determines whether the received temperature data is a high temperature or a low temperature.

An example of the present application provides an electronic device, comprising:

one or more memory systems according to any one of the above examples; and

a host coupled to the memory system.

An example of the present application provides a computer-readable storage medium having instructions stored therein, wherein when the instructions run on a control circuit, implement a method for controlling a memory system as provided in the preceding examples of the present application.

In the present application, the terms “first” and “second” are for descriptive purposes only and are not to be construed as indicating or implying relative importance. The term “at least one” refers to one or more, and the term “plurality” refers to two or more unless defined otherwise.

The term “at least one of … or …” in the present application is merely an association relationship for describing associated objects, indicating that there may be three relationships. For example, at least one of A or B may represent that: A is alone, both A and B, and B alone. In addition, the character “/” is used herein to generally indicate an “or” relationship between associated objects.

The present application provides a memory system, an electronic device, a method for controlling a memory system and a storage medium. The technical solution is as follows:

In an aspect, a memory system is provided, comprising a memory device and a memory controller, wherein

the memory controller is configured to:

acquire signal offset data for a reference clock signal in response to identifying a state abnormal event, wherein the signal offset data indicates an offset status of the reference clock signal; and

execute an offset processing strategy in response to the signal offset data reaching an offset threshold.

In an example, the signal offset data indicates an offset status between a physical manifestation of the reference clock signal and configuration information; and

the physical manifestation comprises a manifested frequency of the reference clock signal, and the configuration information comprises a configuration frequency and is sent by a host.

In an example, the memory controller is further configured to:

execute an offset processing strategy corresponding to the state abnormal event in response to the signal offset data reaching the offset threshold.

In an example, the memory controller is further configured to:

acquire the signal offset data for the reference clock signal in response to an operating temperature of the memory system meeting a preset temperature requirement; and

adjust a time interval for sending a feedback signal to a host in response to the signal offset data reaching the offset threshold.

In an example, the memory controller is further configured to:

increase the time interval for sending the feedback signal to the host in response to the operating temperature of the memory system reaching a first temperature threshold and the signal offset data reaching the offset threshold.

In an example, the memory controller is further configured to:

decrease the time interval for sending the feedback signal to the host in response to the operating temperature of the memory system being less than a second temperature threshold and the signal offset data being less than the offset threshold, wherein the second temperature threshold is less than the first temperature threshold.

In an example, the memory controller is further configured to:

control the memory system to execute a power consumption operation in response to the operating temperature of the memory system being less than the second temperature threshold, wherein the power consumption operation is to control the memory system to generate additional power consumption based on power consumption of read-write operations.

In an example, the memory controller is further configured to:

acquire the signal offset data for the reference clock signal in response to a hardware reset event; and

increase a latency for hardware initialization of the hardware reset event in response to the signal offset data reaching the offset threshold.

In an example, the memory controller is further configured to:

add an initialization operation during the hardware initialization in response to the signal offset data reaching the offset threshold, wherein the initialization operation comprises at least one of a hardware self-test operation or a firmware checking operation.

In an example, the memory controller is further configured to:

acquire the signal offset data for the reference clock signal in response to a voltage abnormal event; and

execute a recovery processing flow for device management entity (DME) errors in response to the signal offset data reaching the offset threshold.

In an example, the memory controller is further configured to:

acquire the signal offset data for the reference clock signal in response to the number of device management entity (DME) errors reaching a number threshold; and

record a signal offset event of the reference clock signal in response to the signal offset data reaching the offset threshold.

In an example, the memory controller comprises a clock analyzer, wherein

the clock analyzer is configured to acquire the signal offset data for the reference clock signal.

In an example, the memory controller is further configured to:

record a signal offset event of the reference clock signal in response to the signal offset data reaching the offset threshold.

In an example, the signal offset event comprises a signal gear for the reference clock signal.

In an example, the memory system comprises a universal flash memory (UFS).

In another aspect, an electronic device is provided, comprising:

a memory system as described in any of the above examples; and

a host coupled to the memory system.

In another aspect, a method for controlling a memory system is provided, comprising:

acquiring signal offset data for a reference clock signal in response to identifying a state abnormal event, wherein the signal offset data indicates an offset status of the reference clock signal; and

executing an offset processing strategy in response to the signal offset data reaching an offset threshold.

In an example, the signal offset data indicates an offset status between a physical manifestation of the reference clock signal and configuration information; and

the physical manifestation comprises a manifested frequency of the reference clock signal, and the configuration information comprises a configuration frequency and is sent by a host.

In an example, the executing a preset offset processing strategy in response to the signal offset data reaching an offset threshold comprises:

executing an offset processing strategy corresponding to the state abnormal event in response to the signal offset data reaching the offset threshold.

In an example, the acquiring signal offset data for a reference clock signal in response to identifying a state abnormal event comprises:

acquiring the signal offset data for the reference clock signal in response to an operating temperature of the memory system meeting a preset temperature requirement; and

the executing a preset offset processing strategy corresponding to the state abnormal event in response to the signal offset data reaching the offset threshold comprises:

adjusting a time interval for sending a feedback signal to a host in response to the signal offset data reaching the offset threshold.

In an example, the acquiring the signal offset data for the reference clock signal in response to an operating temperature of the memory system meeting a preset temperature requirement comprises:

acquiring the signal offset data for the reference clock signal in response to the operating temperature of the memory system reaching a first temperature threshold; and

the adjusting a time interval for sending a feedback signal to a host in response to the signal offset data reaching the offset threshold comprises:

increasing the time interval for sending the feedback signal to the host in response to the signal offset data reaching the offset threshold.

In an example, the method further comprises:

decreasing the time interval for sending the feedback signal to the host in response to the operating temperature of the memory system being less than a second temperature threshold and the signal offset data being less than the offset threshold, wherein the second temperature threshold is less than the first temperature threshold.

In an example, the method further comprises:

controlling the memory apparatus to execute a power consumption operation, wherein the power consumption operation is to control the memory system to generate additional power consumption based on power consumption of read-write operations.

In an example, the acquiring signal offset data for a reference clock signal in response to identifying a state abnormal event comprises:

acquiring the signal offset data for the reference clock signal in response to a hardware reset event; and

the executing an offset processing strategy corresponding to the state abnormal event in response to the signal offset data reaching the offset threshold comprises:

increasing a latency for hardware initialization of the hardware reset event in response to the signal offset data reaching the offset threshold.

In an example, the increasing a latency for hardware initialization of the hardware reset event in response to the signal offset data reaching the offset threshold comprises:

adding an initialization operation during the hardware initialization in response to the signal offset data reaching the offset threshold, wherein the initialization operation comprises at least one of a hardware self-test operation or a firmware checking operation.

In an example, the acquiring signal offset data for a reference clock signal in response to identifying a state abnormal event comprises:

acquiring the signal offset data for the reference clock signal in response to a voltage abnormal event; and

the executing an offset processing strategy corresponding to the state abnormal event in response to the signal offset data reaching the offset threshold comprises:

executing a recovery processing flow for device management entity (DME) errors in response to the signal offset data reaching the offset threshold.

In an example, the acquiring signal offset data for a reference clock signal in response to identifying a state abnormal event comprises:

acquiring the signal offset data for the reference clock signal in response to the number of device management entity (DME) errors reaching a number threshold; and

the executing an offset processing strategy corresponding to the state abnormal event in response to the signal offset data reaching the offset threshold comprises:

recording a signal offset event of the reference clock signal in response to the signal offset data reaching the offset threshold.

In an example, the acquiring signal offset data for a reference clock signal comprises:

acquiring, by a clock analyzer, the signal offset data for the reference clock signal.

In an example, the method further comprises:

recording a signal offset event of the reference clock signal in response to the signal offset data reaching the offset threshold.

In an example, the signal offset event comprises a signal gear for the reference clock signal.

In an example, the memory system comprises a universal flash memory (UFS).

In another aspect, non-volatile readable storage medium is provided, , having at least one computer program stored therein, wherein the at least one computer program is loaded and executed by a processor to implement the method for controlling the memory system mentioned in any of the above examples.

The technical solutions provided in this application may achieve the following beneficial effects.

When the operating environment of the memory system is unstable, the signal offset data for the reference clock signal is acquired, and the current operating stability condition of the memory system is identified with assistant of the signal offset data. When the signal offset data for the reference clock signal reaches the offset threshold, it means that the operating environment of the memory system is unstable, which will affect the read/write accuracy of the memory system. Therefore, the offset processing strategy is executed to improve the operating stability of the memory system.

The above descriptions are merely examples of the present application, and are not intended to limit the present application, and any modifications, equivalent substitutions and improvements made within the spirit and principle of the present application should be included within the protection scope of the present application.

What is claimed is:

1. A memory system, comprising:
a memory device; and
a memory controller configured to:
acquire signal offset data for a reference clock signal in response to a state abnormal event, wherein the signal offset data indicates an offset status of the reference clock signal; and
execute an offset processing strategy in response to the signal offset data satisfying an offset threshold.

2. The memory system of claim 1, wherein,
the signal offset data indicates the offset status between a physical manifestation of the reference clock signal and configuration information;
the physical manifestation comprises a manifested frequency of the reference clock signal; and
the configuration information comprises a configuration frequency and is sent by a host.

3. The memory system of claim 1, wherein the memory controller is configured to:
execute the offset processing strategy corresponding to the state abnormal event in response to the signal offset data satisfying the offset threshold.

4. The memory system of claim 3, wherein the memory controller is further configured to:
acquire the signal offset data for the reference clock signal in response to an operating temperature of the memory system satisfying a temperature threshold; and
in response to the signal offset data satisfying the offset threshold, adjust a time interval for sending a feedback signal to a host.

5. The memory system of claim 4, wherein the memory controller is further configured to:
in response to the operating temperature of the memory system satisfying a first temperature threshold and the signal offset data satisfying the offset threshold, increase the time interval for sending the feedback signal to the host.

6. The memory system of claim 5, wherein the memory controller is further configured to:
in response to the operating temperature of the memory system being less than a second temperature threshold and the signal offset data being less than the offset threshold, decrease the time interval for sending the feedback signal to the host, wherein the second temperature threshold is less than the first temperature threshold.

7. The memory system of claim 6, wherein the memory controller is further configured to:
in response to the operating temperature of the memory system being less than the second temperature threshold, control the memory system to execute a power consumption operation, wherein the power consumption operation is to control the memory system to consume additional power based on power consumption of read-write operations.

8. The memory system of claim 3, wherein the memory controller is further configured to:
acquire the signal offset data for the reference clock signal in response to a hardware reset event; and
in response to the signal offset data satisfying the offset threshold, increase a latency for hardware initialization of the hardware reset event.

9. The memory system of claim 8, wherein the memory controller is further configured to:
in response to the signal offset data satisfying the offset threshold, add an initialization operation during the hardware initialization, wherein the initialization operation comprises at least one of a hardware self-test operation or a firmware checking operation.

10. The memory system of claim 3, wherein the memory controller is further configured to:
acquire the signal offset data for the reference clock signal in response to a voltage abnormal event; and
execute a recovery processing flow for device management entity (DME) errors in response to the signal offset data satisfying the offset threshold.

11. The memory system of claim 3, wherein the memory controller is further configured to:
acquire the signal offset data for the reference clock signal in response to a number of device management entity (DME) errors satisfying a number threshold; and
record a signal offset event of the reference clock signal in response to the signal offset data satisfying the offset threshold.

12. The memory system of claim 1, wherein the memory controller comprises:
a clock analyzer configured to acquire the signal offset data for the reference clock signal.

13. The memory system of claim 1, wherein the memory controller is further configured to:
record a signal offset event of the reference clock signal in response to the signal offset data satisfying the offset threshold.

14. The memory system of claim 13, wherein the signal offset event comprises a signal gear for the reference clock signal.

15. An electronic device, comprising:
a memory system, comprising:
a memory device; and
a memory controller configured to:
acquire signal offset data for a reference clock signal in response to a state abnormal event, wherein the signal offset data indicates an offset status of the reference clock signal; and
execute an offset processing strategy in response to the signal offset data satisfying an offset threshold; and
a host coupled to the memory system.

16. A method of controlling a memory system, the method comprising:
acquiring signal offset data for a reference clock signal in response to a state abnormal event, wherein the signal offset data indicates an offset status of the reference clock signal; and
executing an offset processing strategy in response to the signal offset data satisfying an offset threshold.

17. The method of claim 16, wherein:
the signal offset data indicates the offset status between a physical manifestation of the reference clock signal and configuration information;
the physical manifestation comprises a manifested frequency of the reference clock signal; and
the configuration information comprises a configuration frequency and is sent by a host.

18. The method of claim 16, wherein the offset processing strategy corresponds to the state abnormal event.

19. The method of claim 18, wherein:
the acquiring of the signal offset data for the reference clock signal comprises:
acquiring the signal offset data for the reference clock signal in response to an operating temperature of the memory system satisfying a temperature threshold; and
the executing of the offset processing strategy comprises:
in response to the signal offset data satisfying the offset threshold, adjusting a time interval for sending a feedback signal to a host.

20. The method of claim 19, wherein the adjusting of the time interval for sending the feedback signal to the host comprises increasing the time interval for sending the feedback signal to the host.
